(19) United States
(12) Patent Application Publication
(10) Pub. No.: US 2007/0062095 A1
(43) Pub. Date: Mar. 22, 2007

(54) Aimable Fishing Rod in the Shape of a Fish

(76) Inventor: Justin Euliano, Oceanside, NY (US)

Correspondence Address: THELEN REID BROWN RAYSMAN & STEINER LLP, 900 THIRD AVENUE, NEW YORK, NY, 10022, US

(21) Appl. No.: 11/534,338

(22) Filed: Sep. 22, 2006

Related U.S. Application Data
(60) Provisional application No. 60/719,526, filed on Sep. 22, 2005.

(51) Int. Cl. A01K 91/02

(52) U.S. Cl. 43/19

(57) ABSTRACT

The compact aimable fishing rod according to an embodiment of the present invention comprises a body portion, a reel unit, a trigger member, and a compression coil spring adapted to provide a launching force to a projectile coupled to a bobber and a fishing line. The body portion includes a handle and a projectile discharge slot which the rear end of the projectile is to be inserted for launching. The compression coil spring is disposed in the projectile discharge slot. One end of the spring is seated against the end of the projectile discharge slot, and the other end of the spring is seated against the projectile. By aiming the fishing rod in at a desired target and pulling rearwardly on the trigger member, the projectile coupled to the bobber and fishing line is launched by physical contact with a compression spring from the projectile discharge slot.

### CROSS-REFERENCE TO RELATED APPLICATIONS

The present application is based on, and claims priority from, U.S. Provisional Patent No. 60/719,526, filed Sep. 22, 2005, which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

This invention relates to fishing rods and, more particularly, to a compact fishing line casting apparatus for use in connection with launching a fishing hook and bobber at a desired location by pressing a trigger.

One of the more important steps in fishing is casting, which is the act of tossing the hook and/or bobber coupled to a fishing line into a body of water. Casting using a conventional fishing rod generally requires two steps: first, releasing the line from the reel; and then, sweeping the rod forward from overhead using wrist action to propel the line to the desired fishing location.

Users of all skill-levels experience several common problems when casting with conventional fishing rods. For example, the line can become tangled on overhead tree branches, bushes, boat railings, and other obstacles. As another example, excess fishing line can become wrapped around the rod preventing the fisher from casting the line. Furthermore, novice fishers, children, and fishers with physical disabilities can be unable to propel a fishing line to a desired distance.

To overcome the above problems and others, a compact fishing rod is needed to allow a fisher to cast the line at great distances without requiring a swinging force of the arms or wrists.

### BRIEF SUMMARY OF THE INVENTION

The present invention overcomes the foregoing problems of conventional fishing rods by providing a compact aimable fishing rod apparatus for launching a fishing line coupled to a hook and a bobber to a desired location in a river, stream, lake, or another body of water by pressing a trigger. In an embodiment, the aimable fishing rod apparatus includes a body portion configured in the shape of a fish, a reel unit, a trigger member, a projectile discharge slot, and a compression coil spring adapted to provide a launching force to a projectile coupled to the fishing hook and bobber. The compression coil spring is disposed in the projectile discharge slot. One end of the spring is seated against the end of the projectile discharge slot, and the other end of the spring is seated against a projectile. By pulling rearwardly on the trigger member, the projectile, which is coupled to the bobber and fishing line, is launched by physical contact with the compression spring from the projectile discharge slot.

In accordance with various embodiments of the present invention, the fishing rod apparatus eliminates the need for sweeping the rod forward using wrist action to propel the line to the desired fishing location. And because the fishing rod apparatus is more compact than conventional rods, it is easier to use and carry. Furthermore, the fishing rod apparatus is configured in a unique shape making it more appealing to younger children, as well as adults.

The above described and many other features of the present invention will become apparent, as the present invention becomes better understood by reference to the following detailed description when considered in conjunction with the accompanying drawings.

### DESCRIPTION OF THE DRAWINGS

The present invention is illustrated in the figure(s) of the accompanying drawing(s), which are meant to be exemplary and not limiting, in which like references indicate identical or functionally similar elements, and in which:

FIG. 1 illustrates a side elevational view of a compact fishing rod according to an embodiment of the present invention.

### DETAILED DESCRIPTION

In the following description of embodiments of the present invention, reference is made to the accompanying drawings that form a part hereof and in which is shown by way of illustration a number of specific embodiments in which the present invention can be practiced. It is to be understood that other embodiments can be utilized and structural changes can be made without departing from the scope of the present invention.

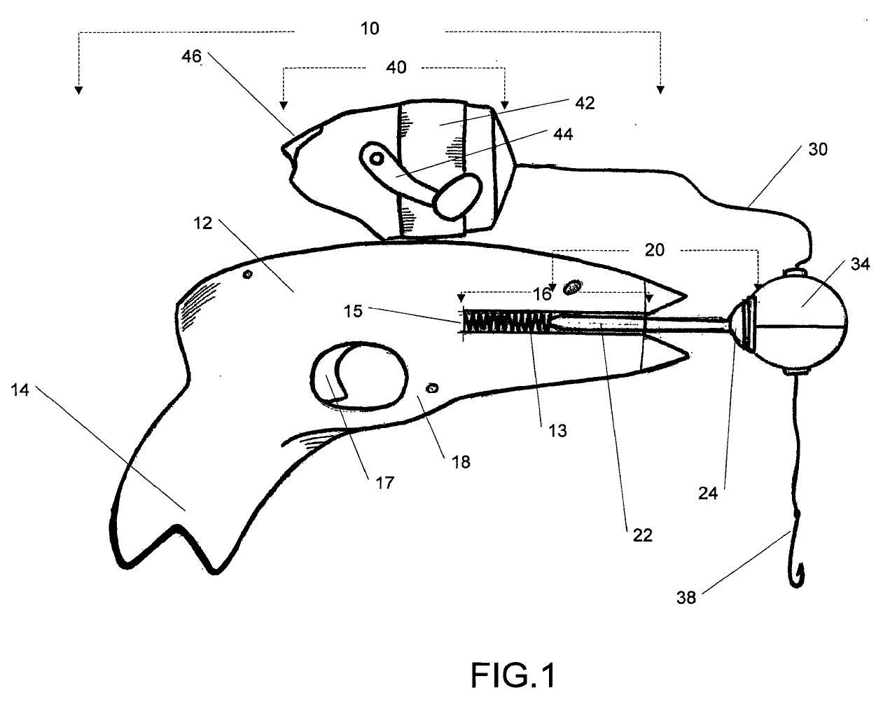

FIG. 1 illustrates an embodiment of an aimable fishing rod 10 that includes a fish-shaped body portion 12, a reel unit 40, a compression spring 13, a trigger guard 18, and a trigger member 17. The body portion 12 of the fishing rod 10 is composed of plastic, wood, or other suitable materials. The body portion 12 is shaped so as to define a handle 14 at the rear end, which can be grasped and manipulated by a user during use. The front end of the body portion 12 includes a projectile discharge slot 16 for launching a projectile 20 therefrom. The body portion 12 can be configured in the general shape of a fish, as shown, however, other shapes are possible. In an embodiment, the body portion 12 is a spring-loaded dart gun, and the projectile 20 is a dart having a bobber 34 (discussed below) attached to the suction part of the dart.

As shown in FIG. 1, the reel unit 40 is mounted to the upper side of the body portion 12; however, the reel unit 40 can be positioned at other suitable locations with respect to body portion 12. The reel unit 40 comprises a spool (not shown) mounted rotatively within the reel unit 40 for winding a fishing line 30, an outer frame 42 for covering the spool, a handle 44 that is disposed on one side of the reel unit 40 for rotating the spool, and a spool release button 46. As shown in FIG. 1, the reel unit 40 can be a closed-face spinning reel that comprises a closed frame 42 covering the spool and a hole through which the line 30 passes. Alternatively, other types of reels can be utilized for reel 40 to support different types of fishing and includes spinning reels, bait casting reels, and fly casting reels. The safety release button 46, mounted on the end of the reel unit 40 can be operated to retain the spool in a locked position or allow it to rotate freely when casting or reeling in fish.

A length of fishing line 30 is attached at one end to the spool and has an attachment hook 38, attached to its other end. The fishing line 30 is composed of a clear and durable monofilament nylon or any other suitable material. The material of the line 30 to be used in the present invention is not particularly limited to a particular cord strength, color or thickness.

Each of the projectiles 20, as shown in FIG. 1, comprises a substantially cylindrical body 22 composed of a light-weight plastic or any other suitable material having similar properties. A suction cup 24 is adhered or molded to the front end of the cylindrical body 22.

As shown in FIG. 1, the oval-shaped suction cup 24 of the projectile 20 protruding from the projectile discharge slot 16 is secured to a round bobber 34 that can be made of a lightweight plastic material. The shape and construction of the bobber 34, however, can vary considerably. The bobber 34 is connected to the fishing line 30 at a location adjacent to the hook 38 using any suitable means. When discharged from the projectile discharge slot 16 in accordance with embodiments of the present invention, the bobber 34 floats in a body of water and marks the location of the line 30 and hook 38.

The fishing rod 10 includes a trigger member 17 extending into the trigger guard 18. The trigger member 17 can be molded from plastic or any other suitable material. The trigger member 17 is adapted to release the projectile 20 after it has been secured in the projectile discharge slot 16.

Referring to FIG. 1, there is shown a compression spring 13 in a compressed state with a projectile 20 extending from the projectile discharge slot 16. The compression coil spring 13 is disposed in the projectile discharge slot 16 and is seated at one end against the end 15 of the projectile discharge slot 16, the other end of the spring 13 being seated against the projectile 20. When the spring 13 is not compressed (not shown), it is substantially coextensive with the projectile discharge slot 16.

The operation of the aimable fishing rod 10, will now be described with reference to FIG. 1. To operate the aimable fishing rod 10 as described above, a rear end of the body 22 of a projectile 20 is inserted into the projectile discharge slot 16 until the projectile 20 is secured in place. Once the projectile 20 is secured, the spring 13 is retained in a compressed state. The bobber 34 is attached to the suction cup 24 of the projectile 20. Next, the fishing rod 10 is aimed in the direction of where the user desires to fish. The release button 46 of the reel unit 40 is then moved to the operational position, which enables the spool to rotate freely. Afterwards, the trigger member 17 is pulled rearwardly to release the projectile 20 from its secured position, which causes the spring 13 to push forward. As a result, the projectile 20 coupled to the bobber 34 and fishing line 30 is propelled by physical contact with the spring 13 to the desired location in the river, stream, lake or other body of water.

Notably, the figures and examples above are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). Moreover, it is not intended for any term in the specification or claims to be ascribed an uncommon or special meaning unless explicitly set forth as such. Further, the present invention encompasses present and future known equivalents to the known components referred to herein by way of illustration.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A compact fishing rod apparatus in the shape of a fish for propelling a fishing line coupled to a projectile, comprising:
a body portion having a handle disposed at a first end of the body portion and a projectile discharge slot disposed at a second end of the body portion, wherein the projectile slot is adapted for receiving the projectile;
a reel unit coupled to a first area of the body portion, wherein the reel unit includes a spool for storing and dispensing the line;
a compression spring coupled to the projectile discharge slot, wherein the compression spring is adapted to provide a launching force to the projectile; and
a trigger member coupled to a second area of the body portion, wherein the trigger member is adapted to release the projectile retained in the projectile discharge slot.

2. The compact fishing rod of claim 1, wherein the projectile includes a suction cup disposed at one end of the projectile.

3. The compact fishing rod of claim 1, wherein the reel unit comprises a safety release button for releasing the line on the spool.

4. The compact fishing rod of claim 1, wherein the reel unit comprises a handle for winding the line onto the spool.

5. The compact fishing rod of claim 1, further comprising a bobber detachably coupled to the projectile.

6. The compact fishing rod of claim 5, further comprising a hook attached to one end of the line and suspending from the bobber.
